(19) United States
(12) Patent Application Publication
(10) Pub. No.: US 2008/0297702 A1
(43) Pub. Date: Dec. 4, 2008

(54) Light Emitting Diode Package and Driving Method Thereof

(76) Inventors: Yong Gu Cho, Uiwang-si (KR); Hyun Ha Hwang, Gangnam-gu (KR)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 12/094,990

(22) PCT Filed: Nov. 22, 2006
(86) PCT No.: PCT/KR2006/004925

§ 371 Date: May 24, 2008

(30) Foreign Application Priority Data
Nov. 24, 2005 (KR) 10-2005-0112831

(51) Int. Cl. G02F 1/1335; G09G 3/36

(52) U.S. Cl. 349/68; 345/102

(57) ABSTRACT

A light emitting diode package according to an embodiment of the present invention includes a plurality of red LEDs, green LEDs and blue LEDs arranged for emitting a white light using a color mixing, at least one white LED emitting the white light and a printed circuit board having a circuit pattern for driving the plurality of red LEDs, green LEDs, blue LEDs, and white LEDs.

### TECHNICAL FIELD

The present invention relates to a light emitting diode package and a driving method thereof.

### BACKGROUND ART

According to recent tendency toward miniaturization and lightweight of a variety of electrical appliances, liquid crystal display devices have been in the limelight. Therefore, liquid crystal panels used as a display screen have been also developed in thin type liquid crystal panels.

This liquid crystal panel is widely used as a display device for a mobile terminal, a spaceship, an airplane and a notebook computer. The liquid crystal display device includes an auxiliary light source for emitting light into the liquid crystal panel.

Cold cathode fluorescent lamps (CCFL) are generally used as a related art light source. However, recently, light emitting diodes (hereinafter referred to as “LED”) having low power consumption, high power, quick responsiveness and environment-friendly characteristic are widely used as a light source.

White light is implemented in order to use an LED as an illumination source. A method for implementing the white light using the LED is largely divided into three methods.

First, the white light is implemented by mixing light of three LEDs emitting the three primary colors of light (red, green and blue). The three LEDs are used for making one white light source.

Second, the white light is implemented by exciting a yellow phosphor using a blue LED as a light source.

Lastly, the white light is implemented by exciting a three primary color phosphor using an ultraviolet light emitting LED as a light source.

Generally, the white light is implemented by mixing light of three LEDs emitting red, green and blue light considering reliability of light output according to using long hours.

For example, as illustrated in FIG. 1, a light emitting diode package where LEDs 32R, 32G and 32B emitting red, green, blue light are installed is disposed on one side surface of a liquid crystal panel 10 and light emitted from the LEDs 32R, 32G and 32B is guided using a light guide plate 40 etc. to provide light.

Also, as illustrated in FIG. 2, The light guide plate 40 may be installed adjacent to the LED such that the red, green and blue light emitted from an LED 32R-1, 32G-1, 32B-1, 32R-2, 32G-2 and 32B-2 are mixed and provided to a liquid crystal display device.

The light emitted from the red, green and blue LEDs 32R-1, 32G-1, 32B-1, 32R-2, 32G-2 and 32B-2 are mixed within the light guide plate 40 and then incident into the liquid crystal panel to implement an image.

That is, the light emitted from each of the LEDs having a different delay time are uniformly mixed in a light guide plate region 40a adjacent to the LEDs and scattered by a pattern formed in the remaining light guide plate region 40b. Therefore, the light emitted from the LEDs is provided to the liquid crystal panel.

The red, green and blue LEDs 32R-1, 32G-1 and 32B-1 must be turned on simultaneously in order to emit the white light by the above method.

Thus, the red, green and blue LEDs 32R-1, 32G-1 and 32B-1 are mounted on the a printed circuit board 31, where a circuit pattern is formed to form the light emitting diode package 30 such that the red, green and blue LEDs 32R-1, 32G-1 and 32B-1 are simultaneously driven according to a uniform driving current applying signal.

In order to increase quantity of light according to a size and area of the liquid crystal panel, the another red, green and blue LEDs 32R-2, 32G-2 and 32B-2 are mounted on the a printed circuit board 31, where a circuit pattern is formed and driven according to a control circuit as illustrated in FIG. 3 such that the red, green and blue LEDs 32R-2, 32G-2 and 32B-2 are simultaneously driven according to a uniform driving current applying signal.

However, although the red, green and blue LEDs 32R-1, 32G-1 and 32B-1 are connected to one circuit to simultaneously light-emit by a uniform driving current value, that is uniform current flows into each of the LEDs, light having a different brightness is emitted because the red, green and blue LEDs 32R-1, 32G-1 and 32B-1 have different device characteristics each other.

Therefore, the red, green and blue LEDs 32R-1, 32G-1 and 32B-1 must be individually controlled to adjust the driving current in order to emit the white light having required white balance.

Generally, a red LED voltage generator, a green LED voltage generator and a blue LED voltage generator are formed corresponding to the red LED 32R-1, the green LED 32G-1 and the blue LED 32B-1, respectively, to individually control the LEDs. However, this method increases a manufacturing cost because of fabricating an individual voltage generator.

Although an LED chip where output light is adjusted such that the uniform driving current is applied and the uniform brightness is provided may be fabricated, this method increases manufacturing cost because an auxiliary process is required.

Also, light intensity and brightness incident into the liquid crystal panel are low because each of single light emitting LEDs of the red, green and blue colors generally has low brightness compared to another light sources, thereby deteriorating display quality.

In the case where the driving current is increased in order to obtain light of high voltage output from the red LEDs 32R-1 and 32R-2, the green LEDs 32G-1 and 32G-2 and the blue LEDs 32B-1 and 32B-2, temperature rises because high temperature is occurred in the LEDs to increase resistance, thereby deteriorating light efficiency.

Also, in the light guide plate, the light mixing region 40a mixing for obtaining a multi-color image from the three primary colors (red, green and blue) is additionally required. Therefore, the light guide region 40b where actual light is emitted in the light guide plate 40 is narrowed, and a volume of the liquid crystal panel is increased.

### DISCLOSURE OF INVENTION

### Technical Problem

An embodiment of the present invention provides a light emitting diode package capable of implementing high color reproduction and providing white light having excellent brightness and a driving method thereof.

### Technical Solution

An embodiment of the present invention provides a light emitting diode package including: a plurality of red LEDs, green LEDs and blue LEDs arranged for emitting a white light using a color mixing; at least one white LED emitting a white light; and a printed circuit board having a circuit pattern for driving the plurality of red LEDs, green LEDs, blue LEDs, and white LEDs.

An embodiment of the present invention provides a driving method of a light emitting diode package having a printed circuit board where a circuit pattern for driving an LED is formed, and a plurality of red LEDs, green LEDs, blue LEDs and white LEDs formed on the printed circuit board, the method including: driving the plurality of LEDs individually according to a LED colors by applying different driving currents to the plurality of red LEDs, green LEDs and blue LEDs so as to form white light by color mixing; and emitting the white light by applying a current to the white LED.

An embodiment of the present invention provides a liquid crystal display device including: a liquid crystal panel displaying an image; a light emitting diode package including a plurality of red LEDs, green LEDs and blue LEDs arranged for emitting a white light using a color mixing, a plurality of white LEDs emitting a white light, and a printed circuit board having a circuit pattern for driving the plurality of red LEDs, green LEDs, blue LEDs, and white LEDs; and a light guide plate providing light emitted from the light emitting diode package to the liquid crystal panel.

### Advantageous Effects

In according to an embodiment of the present invention, the white LEDs is arranged together with the three primary color LEDs for mixing colors to form the light emitting diode package, thereby being capable of providing the light having the excellent color reproduction and brightness.

In according to an embodiment of the present invention, the brightness can be improved using the white LEDs without increasing the light output of three primary color LEDs for mixing colors. Therefore, the LEDs of the light emitting diode package can be prevented from the deterioration. Also, as the deterioration of the liquid crystal display device is prevented, a change according to a color coordinate, a peak wavelength and a full width at half maximum of a display screen can be also prevented.

In according to an embodiment of the present invention, the plurality of LEDs installed in the light emitting diode package is operated according to the emitted colors, thereby emitting the white light having an excellent color mixing property.

In according to an embodiment of the present invention, a light emitting intensity of an individual LED for each color light is controlled according to a color-purity deviation of the white light to be emitted, thereby being capable of improving the color reproduction.

### BRIEF DESCRIPTION OF THE DRAWINGS

FIG. 1 is a plan view of an electrical appliance having a liquid crystal panel fitted with a related art emitting diode package.

FIG. 2 is a perspective view illustrating a color mixing of the related art emitting diode package.

FIG. 3 is a circuit diagram illustrating a driving method of the related art emitting diode package.

FIG. 4 is a plan view of an electrical appliance having a liquid crystal panel fitted with an emitting diode package according to an embodiment of the present invention.

FIG. 5 is a perspective view illustrating a color mixing of the emitting diode package according to an embodiment of the present invention.

FIG. 6 is a circuit diagram illustrating a driving method of the emitting diode package according to an embodiment of the present invention.

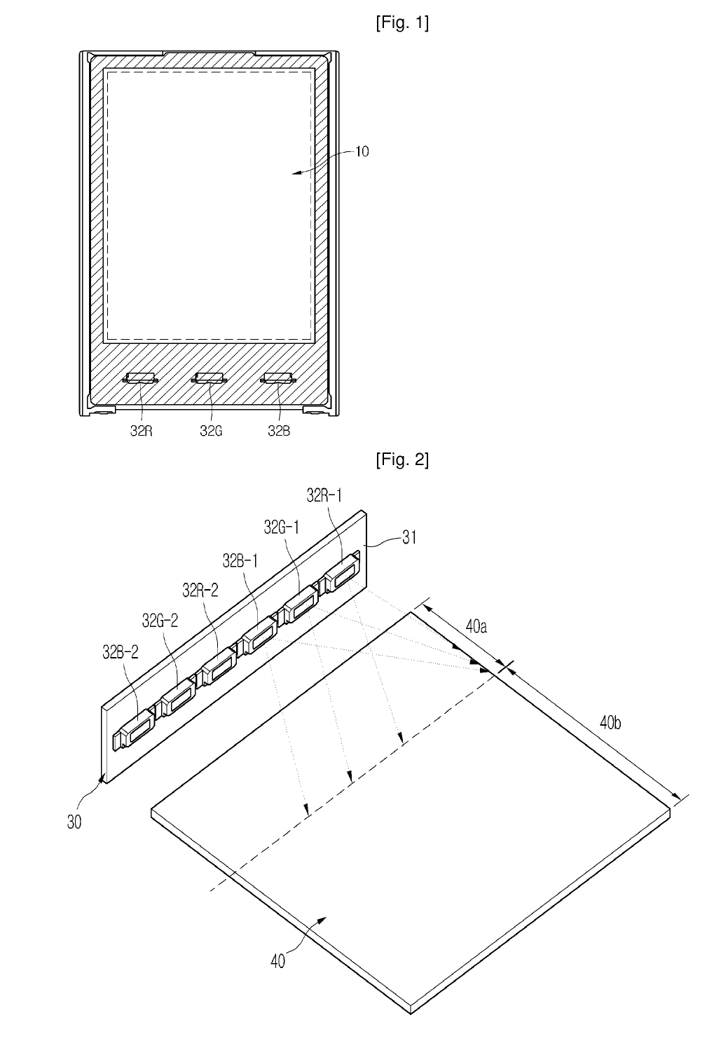

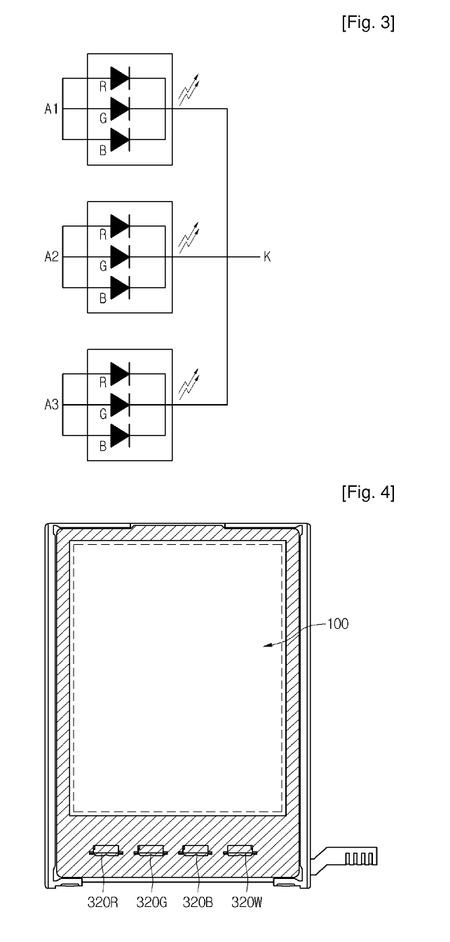

### MODE FOR THE INVENTION

Hereinafter, an emitting diode package and a driving method thereof according to an embodiment of the present invention will be described with reference to the accompanying drawing.

Referring to FIG. 4, the emitting diode package according to an embodiment of the present invention is installed on a side surface of a liquid crystal panel 100, such that the emitting diode package is used as a side light type surface light source of a liquid crystal panel 100 fitted in a mobile terminal.

A plurality of red LEDs 320R, green LEDs 320G, blue LEDs 320B and white LEDs 320W are installed in the emitting diode package such that white light having uniform high brightness is emitted.

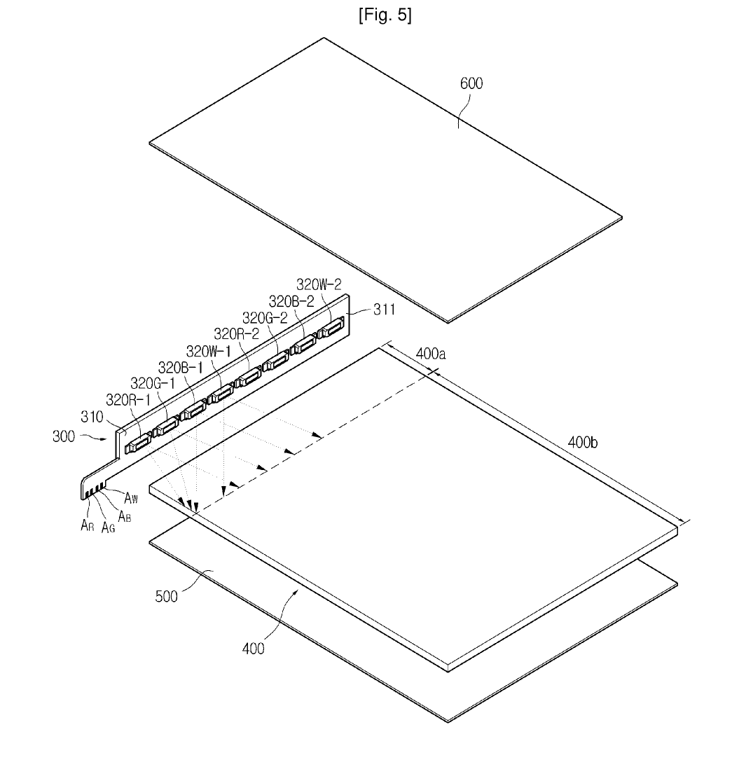

Referring to FIG. 5, a light emitting diode package 300 according to an embodiment of the present invention includes three primary colors (red LEDs 320R-1 and 320R-2, green LEDs 320G-1 and 320G-2, and blue LEDs 320B-1 and 320B-2) and white LEDs 320W-1 and 320W-2.

A plurality of red LEDs 320R-1 and 320R-2, the green LEDs 320G-1 and 320G-2, the blue LEDs 320B-1 and 320B-2 and the white LEDs 320W-1 and 320W-2 are arranged and numerals thereof may be variable according to an area of a liquid crystal panel.

Here, a sequence arrangement of the LEDs is one embodiment of the present invention and may be capable of being changed into various forms. For example, the blue LED, the red LED, the green LED and the white LED may be arranged in order or the white LED may be arranged firstly. Of course, the at least one LED may be sequentially and simultaneously arranged with the plurality of LEDs.

Thus, when the three primary colors such as the red LED, the green LED and the blue LED are simultaneously mixed, the white light may be emitted by mixing these three colors. In the embodiment of the present invention, the white LEDs 320W-1 and 320W-2 are further arranged such that white light having more high brightness is emitted. A numeral of the white LED may be variable and may be formed with at least one.

Here, the light emitting diode package 300 includes a printed circuit board (PCB) 310 where LEDs are mounted. The PCB 310 includes an insulating layer and a driving circuit corresponding to a power line, a control line and an output line for operating the mounted light emitting diode. A photo solder resist (PSR) layer 311 is formed on a surface of the PCB 310 in order to protect a circuit pattern.

Also, the driving circuit is formed such that LEDs of each light emitting color are simultaneously operated. Driving current AR applied to the red LEDs 320R-1 and 320R-2, driving current AG applied to the green LEDs 320G-1 and 320G-2, driving current AB applied to the blue LEDs 320B-1 and 320B-2 and driving current AW applied to the white LEDs 320W-1 and 320W-2 may be different from each other.

When uniform current flows, light having different brightness is generated because the red LEDs 320R-1 and 320R-2, the green LEDs 320G-1 and 320G-2 and the blue LEDs 320B-1 and 320B-2 have different device characteristics from each other.

Thus, currents applied to the red LEDs 320R-1 and 320R-2, the green LEDs 320G-1 and 320G-2 and the blue LEDs 320B-1 and 320B-2 are individually controlled from each other such that light having uniform brightness is emitted in order to satisfy white balance requested by color mixing.

The plurality of red LEDs 320R-1 and 320R-2, green LEDs 320G-1 and 320G-2, blue LEDs 320B-1 and 320B-2 and white LEDs 320W-1 and 320W-2 may be sequentially operated in units of colors. Or, the plurality of red LEDs 320R-1 and 320R-2, green LEDs 320G-1 and 320G-2, blue LEDs 320B-1 and 320B-2 and white LEDs 320W-1 and 320W-2 may be simultaneously operated.

An emission peak of the plurality of white LEDs 320W-1 and 320W-2 may be controlled according to an emission peak of the red LEDs 320R-1 and 320R-2, the green LEDs 320G-1 and 320G-2 and the blue LEDs 320B-1 and 320B-2.

In a liquid crystal display device including the light emitting diode package according to an embodiment of the present invention, a light guide plate 400 is installed adjacent to the light emitting diode package such that light emitted from the LED is incident on a liquid crystal panel.

In the liquid crystal display device according to an embodiment of the present invention, a reflection sheet 500 disposed on a lower of the light guide plate 400 to reflect light emitted into the lower of the light guide plate 400 to a front surface of the liquid crystal display device may be formed. Also, a plurality of prism sheets and diffusion sheets 600 may be installed between the reflection sheet 500 and the liquid crystal panel.

Here, a light mixing region 400a where red, green and blue light are mixed and a light scattering region 400b for emitting light to the liquid crystal panel are existed in the light guide plate 400.

Meanwhile, in the LED mounted on the light emitting diode package according to an embodiment of the present invention, the red LEDs 320R-1 and 320R-2 may be formed using a GaAsP compound semiconductor. Also, the green LEDs 320G-1 and 320G-2 may be formed using a GaP:N type compound semiconductor. The blue LEDs 320B-1 and 320B-2 may be formed using a GaN compound semiconductor.

For example, the white LEDs 320W-1 and 320W-2 may use a LED implementing white light obtained by exciting a yellow phosphor using the blue LED as a light source. Also, the white LEDs 320W-1 and 320W-2 may be formed by exciting three primary color phosphors using an ultraviolet LED as a light source.

For example, the white LEDs 320W-1 and 320W-2, after mounting a semi-conductor chip capable of emitting blue light on a substrate, may be formed including a particle of a light emitting phosphor of at least one type uniformly mixed within epoxy encapsulating the chip.

The phosphor particle convert a part of light emitted from a light emitting diode chip to light of a different spectral wavelength.

Phosphor-LED based lighting systems can generate the white light by converting a part of blue light emitted using various light emitting phosphor particle of at least one on an upper portion of the blue LED to light having much longer wavelength.

The phosphor may be formed by mixing a green, red and yellow phosphor in scale. A green light emitting phosphor denotes all phosphors emitting green color by absorbing blue color. Examples of phosphors corresponding to this group are SrGa2S4:Eu, ZnS:CuAl, ZnS:CuAuAl, SrGa2S4:Eu, ZnGa2S4:Eu and SrS:Ce.

Also, a red light emitting phosphor denotes all phosphors emitting red color by absorbing blue color. Examples of phosphors corresponding to this group are (ZnCd)S:AgCl, (ZnCd)S:AgAuCl, (ZnCd)S:AgAuAl, ZnGa2S4:Mn, SrY2S4:Mn and SrS:Eu.

A method driving the light emitting diode package according to an embodiment of the present invention as a source of the liquid crystal display device will be described below.

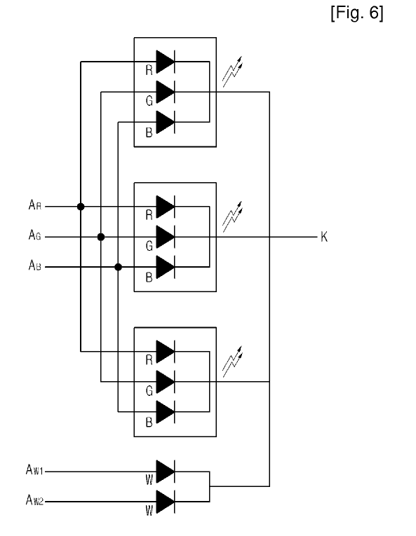

Referring to FIG. 6, different current is provided from a light emitting diode driving integrated circuit (IC) to light emitting diodes of each color such that light emission having uniform brightness with respect to each of colors is achieved. The light emitting diode driving IC may be formed in a module of the liquid crystal display device. For example, the light emitting diode driving IC may be designed such that constant current is provided to each of light emitting diodes by receiving voltage inputted from a battery.

The driving current AR applied to the red LEDs 320R-1 and 320R-2, the driving current AG applied to the green LEDs 320G-1 and 320G-2, the driving current AB applied to the blue LEDs 320B-1 and 320B-2 and the driving current AW applied to the white LEDs 320W-1 and 320W-2 are individually controlled such that light having the uniform brightness can be emitted from each of LEDs.

In driving current applied to the white LEDs 320W-1 and 320W-2, in the case where brightness of white light emitted by the red LEDs, the green LEDs and the blue LEDs is low, the driving current may be applied such that the white LEDs are individually turned on. Therefore, the brightness can be improved.

Also, in a color reproduction of the white LEDs 320W-1 and 320W-2, in the case where an amount of light in a predetermined wavelength is insufficient, the driving current of the red LEDs, the green LEDs and the blue LEDs may be adjusted, thereby being capable of improving the color reproduction.

A wavelength band of light emitted in each of LEDs can be selected such that good color balance is obtained by an LED arrangement according to an embodiment of the present invention. The red LEDs may emit light having a spectrum wavelength of about 610 nanometers (nm), the green LEDs may emit light having a spectrum wavelength of about 530 nm and the blue LEDs may emit light having a spectrum wavelength of about 450 nm to 470 nm.

A resistance ratio is variable according to each of colors to simultaneously control LEDs according to each of colors such that light having uniform brightness is emitted from the LEDs according to each of colors and simultaneously current flowed through the LEDs according to each of colors is adjusted to adjust intensity and brightness of light to be emitted.

Light emitted from the light emitting diode package 300 according to an embodiment of the present invention by this above method is transmitted to the light guide plate 400 as described in FIG. 5.

Mixing light of the white light is emitted in a light mixing region 400a of the light guide plate 400 by LEDs emitting the three primary colors such as the red LED, the green LED and the green LED. Also, white light emitted from the white LEDs is mixed to generate white light having much improved brightness.

Light incident into the light mixing region 400a of the light guide plate 400 is mixed to generate white light. The mixed white light is emitted from a light scattering region 400b of the light guide plate 400 to the diffusion sheet 600. Thus, uniform plane light can be provided to the liquid crystal panel.

As described above, according to an embodiment of the present invention, the light emitting diode package having the improved brightness may be formed by further adding the white LEDs.

Also, white light having high color reproduction is implemented by the red LEDs, the green LEDs and the blue LEDs and the brightness is improved by the white LEDs, thereby being capable of color reproduction and easily implementing a color moving picture.

Also, there is an advantage in that a lowering of light efficiency, deterioration of the liquid crystal display device and power consumption can be reduced because light output of the red LEDs, the green LEDs and the blue LEDs are not excessively increased by improving the brightness using the white LEDs.

### INDUSTRIAL APPLICABILITY

In according to an embodiment of the present invention, the white LEDs is arranged together with the three primary color LEDs for mixing colors to form the light emitting diode package, thereby being capable of providing the light having the excellent color reproduction and brightness.

In according to an embodiment of the present invention, the brightness can be improved using the white LEDs without increasing the light output of three primary color LEDs for mixing colors. Therefore, the LEDs of the light emitting diode package can be prevented from the deterioration. Also, as the deterioration of the liquid crystal display device is prevented, a change according to a color coordinate, a peak wavelength and a full width at half maximum of a display screen can be also prevented.

In according to an embodiment of the present invention, the plurality of LEDs installed in the light emitting diode package is operated according to the emitted colors, thereby emitting the white light having an excellent color mixing property.

In according to an embodiment of the present invention, a light emitting intensity of an individual LED for each color light is controlled according to a color-purity deviation of the white light to be emitted, thereby being capable of improving the color reproduction.

1. A light emitting diode package comprising:
a plurality of red LEDs, green LEDs and blue LEDs arranged for emitting a white light using a color mixing;
at least one white LED emitting a white light; and
a printed circuit board having a circuit pattern for driving the plurality of red LEDs, green LEDs, blue LEDs, and white LEDs.

2. The light emitting diode package according to claim 1, wherein the plurality of red LEDs, green LEDs, blue LEDs and white LEDs are repeatedly arranged in the order named.

3. The light emitting diode package according to claim 1, wherein the plurality of blue LEDs, red LEDs, green LEDs and white LEDs are repeatedly arranged in the order named.

4. The light emitting diode package according to claim 1, wherein the plurality of red LEDs, green LEDs, blue LEDs and white LEDs are divided and connected by the circuit pattern of the printed circuit board such that the LEDs are driven individually according to a LED colors.

5. The light emitting diode package according to claim 1, wherein a light emitting peak of the at least one white LED is adjusted according to a light emitting peak of the red, green and blue LEDs for color mixing.

6. The light emitting diode package according to claim 1, wherein a current applied to the plurality of red LEDs, green LEDs and blue LEDs is adjusted according to each of light emitting colors of LEDs.

7. A driving method of a light emitting diode package including a printed circuit board where a circuit pattern for driving an LED is formed, and a plurality of red LEDs, green LEDs, blue LEDs and white LEDs formed on the printed circuit board, the method comprising:
driving the plurality of LEDs individually according to a LED colors by applying different driving currents to the plurality of red LEDs, green LEDs and blue LEDs so as to form white light by color mixing; and
emitting the white light by applying a current to the white LED.

8. The method according to claim 7, wherein the plurality of red LEDs, green LEDs, blue LEDs and white LEDs are divided and connected by the circuit pattern of the printed circuit board and each of the color LEDs is individually driven.

9. The method according to claim 7, wherein the a light emitting peak of the plurality of white LEDs is adjusted according to a light emitting peak of the red, green and blue LEDs for color mixing.

10. The method according to claim 7, wherein a current applied to the plurality of red LEDs, green LEDs and blue LEDs is adjusted according to each of the color LEDs.

11. The method according to claim 7, wherein the plurality of red LEDs, green LEDs, blue LEDs and white LEDs are driven sequentially according to each of colors.

12. The method according to claim 7, wherein the plurality of red LEDs, green LEDs, blue LEDs and white LEDs are driven simultaneously.

13. A liquid crystal display device comprising:
a liquid crystal panel displaying an image;
a light emitting diode package including a plurality of red LEDs, green LEDs and blue LEDs arranged for emitting a white light using a color mixing, a plurality of white LEDs emitting a white light, and a printed circuit board having a circuit pattern for driving the plurality of red LEDs, green LEDs, blue LEDs, and white LEDs; and
a light guide plate providing light emitted from the light emitting diode package to the liquid crystal panel.

14. The liquid crystal display device according to claim 13, wherein the light emitting diode package is formed on a side surface of the light guide plate.

15. The liquid crystal display device according to claim 13, wherein the plurality of red LEDs, green LEDs, blue LEDs and white LEDs are repeatedly arranged in the order named.

16. The liquid crystal display device according to claim 13, wherein the plurality of blue LEDs, red LEDs, green LEDs and white LEDs are repeatedly arranged in the order named.

17. The liquid crystal display device according to claim 13, wherein the plurality of red LEDs, green LEDs, blue LEDs and white LEDs are divided and connected by the circuit pattern of the printed circuit board such that the LEDs are driven individually according to a LED colors

18. The liquid crystal display device according to claim 13, wherein a light emitting peak of the plurality of white LEDs is adjusted according to a light emitting peak of the red, green and blue LEDs for color mixing.

19. The liquid crystal display device according to claim 13, wherein a current applied to the plurality of red LEDs, green LEDs and blue LEDs is adjusted according to each of the color LEDs.
